(19) United States
(12) Patent Application Publication
(10) Pub. No.: US 2014/0147675 A1
(43) Pub. Date: May 29, 2014

(54) STRUCTURE AND METHOD FOR A GRAPHENE-BASED APPARATUS

(71) Applicant: HCGT LTD., Cortlandt Manor, NY (US)

(72) Inventors: Shu-Jen Han, New York, NY (US); Qing Cao, Yorktown Heights, NY (US)

(73) Assignee: HCGT LTD., Cortlandt Manor, NY (US)

(21) Appl. No.: 13/685,906

(22) Filed: Nov. 27, 2012

(51) Int. Cl. B05D 5/12

(52) U.S. Cl. CPC B05D 5/12; Y10S 977/842; Y10S 977/734; B82Y 30/00
USPC 428/408; 427/113; 977/842; 977/734

(57) ABSTRACT

An approach is provided for a structure and a method for a graphene-based apparatus. The method comprises acts of forming a graphene layer on a metal layer; forming a protective layer on the graphene layer that makes the graphene layer disposed between the metal layer and the protective layer; transferring the protective layer with the graphene layer and the metal layer onto a substrate; removing the metal layer off from the graphene layer; and forming a conducting layer on the graphene layer. Accordingly, the proposed structure of the graphene-based apparatus is able to prevent graphene damage during the transferring, and because of he use of the protective layer in the structure, the roller can be used to apply the stress which enables roll-to-roll type process and significantly improves the manufacturing throughput.

### FIELD OF THE INVENTION

Embodiments of the invention relate to a device and a method for a graphene-based apparatus.

### BACKGROUND

Graphene is a flat monolayer or few layers of carbon atoms tightly packed into a two-dimensional bonded lattice, and is almost completely transparent absorbing only 2.3% of light per layer. In addition, its carrier mobility has been demonstrated to be over 200,000 cm²/VS, which is faster than that of carbon nanotube and silicon. It has approximately 5,300 W/mK of thermal conductivity (better than that of carbon nanotube) and low electric resistance at 10 ohms·cm (lower than that of copper or silver). Accordingly, graphene has attracted great attention due to its outstanding electric and thermal properties. Together with its flexibility and transparency, graphene shows great potential in many different applications such as high-speed transistors, transducers, and transparent electrodes in display, touch panel and solar cell.

However, although graphene has some excellent properties, it can be easily damaged due to its single or few atomic layers nature. Most of large scale graphene films/layers are synthesized on metal substrates (e.g. copper, nickel) which require a transfer step for attaching graphene films to a desired substrate such as plastic, glass or a silicon wafer before they can be utilized. During this transfer step, graphene can easily be damaged and become discontinuous over the large area, which significantly limits its usefulness. The current methods of graphene transfer are still quite rudimentary and the transferred films typically are very resistive without uniformity.

For example, a paper titled “large-area synthesis of high-quality and uniform graphene films on copper foils” (Science, v. 324, p. 1312) teaches a method for graphene transfer. The method of this paper comprises acts of forming a graphene layer on a copper foil, coating a polymethyl methacrylate (PMMA) layer, dissolving the copper layer by gripping the PMMA layer, scooping the graphene/PMMA layers up with a desired substrate and then removing the PMMA layer. However, the method of this paper has very low throughput, leading to very high production cost which significantly limits the manufacturability.

Therefore, there is a need for an approach to provide a structure, a method or both for graphene films transferring, which provides improved control of yield and uniformity over large area, and allows industries to adopt it with high manufacturability.

### SOME EXEMPLARY EMBODIMENTS

These and other needs are addressed by the invention, wherein an approach is provided for a method for a graphene-based apparatus, which is able to prevent graphene damage during the transferring.

Another approach is provided for a device of a graphene-based apparatus, which the structure of the proposed graphene-based apparatus can be easily manufactured by the industries.

According to one aspect of an embodiment of the present invention, a method comprises acts of forming a graphene layer on a metal layer, forming a protective layer on the graphene layer that makes the graphene layer disposed between the metal layer and the protective layer, attaching the protective layer with the graphene layer and the metal layer to a substrate by applying stresses, removing the metal layer from the graphene layer, and forming a conducting layer on the graphene layer. The protective layer is used to absorb the stress during the process and prevent the damage of the graphene layer. The conducting layer is used to bridge any locally discontinues graphene regions to enhance the overall uniformity of conduction.

According to one embodiment, a device comprises the conducting layer, a graphene layer, the protective layer and a substrate stacked vertically. The protective layer is formed on the substrate. The graphene layer is formed on the protective layer. The conductive layer is formed on the graphene layer.

### BRIEF DESCRIPTION OF THE DRAWINGS

The invention is illustrated by way of example, and not by way of limitation, in the figures of the accompanying drawings in which like reference numerals refer to similar elements and in which:

FIG. 1 is an exemplary flowchart of a method for a graphene-based apparatus in accordance with an embodiment of the present invention;

FIGS. 2A-2E are exemplary diagrams of depicting a graphene-based apparatus corresponded to the steps in FIG. 1; and

FIG. 3 is an exemplary diagram of depicting a graphene-based apparatus in accordance with an embodiment of the present invention.

### DESCRIPTION OF THE PREFERRED EMBODIMENT

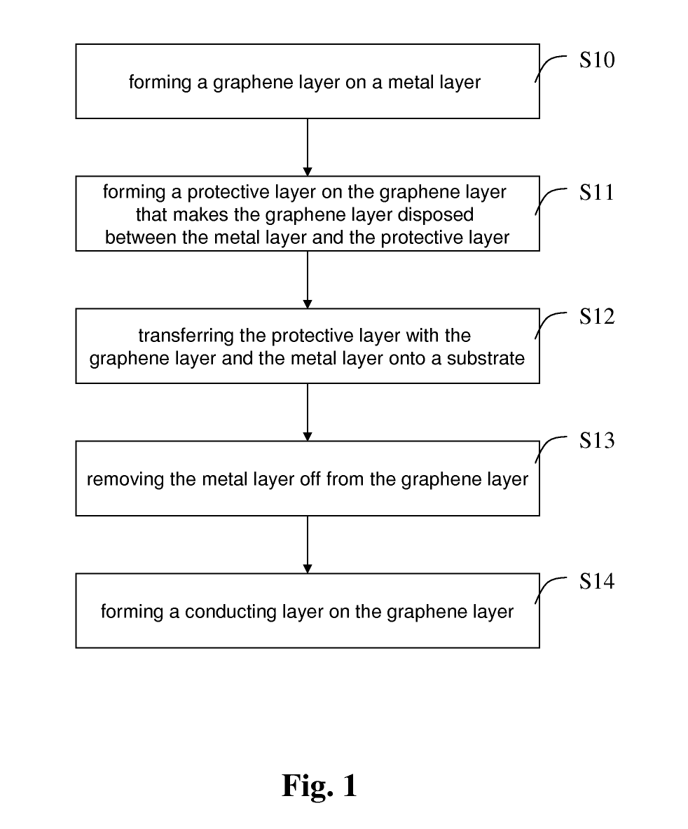

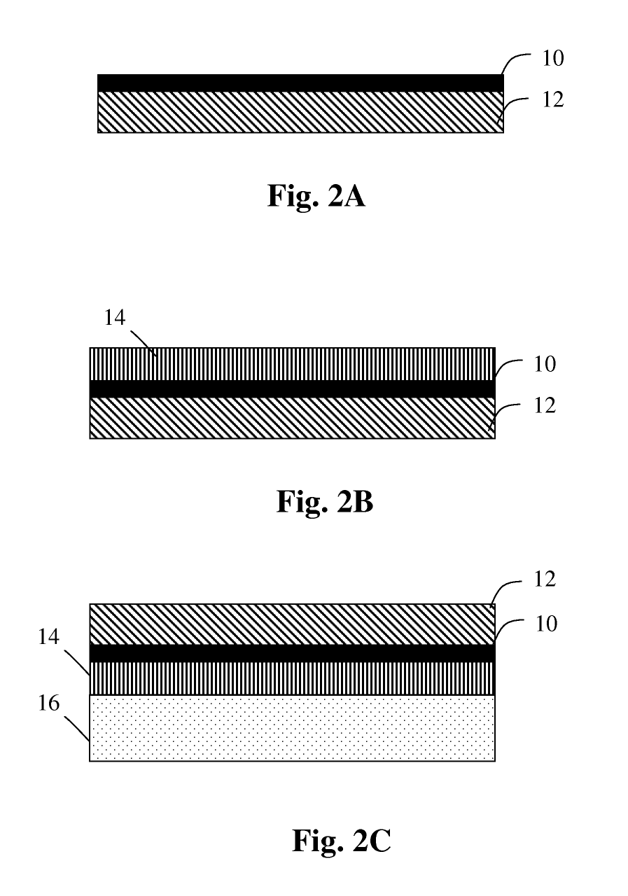

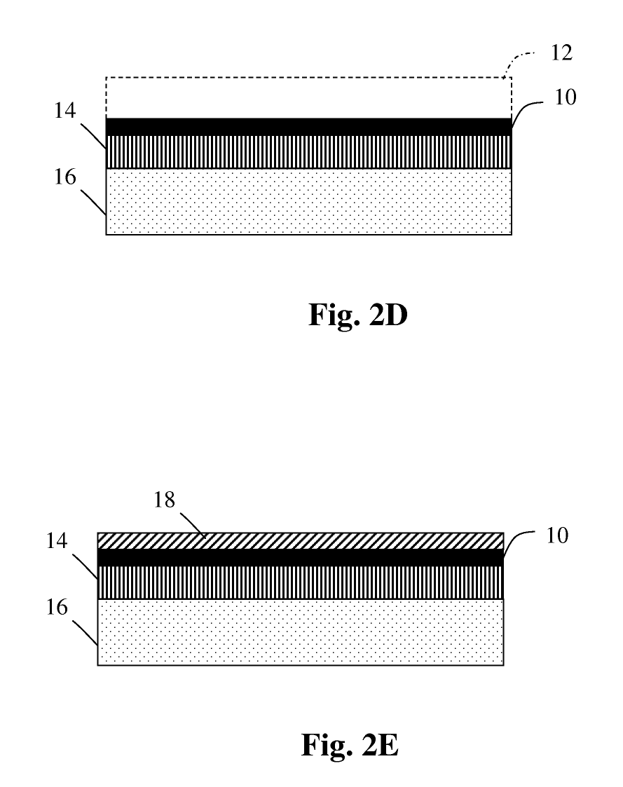

With reference to FIGS. 1-2, FIG. 1 is an exemplary flowchart of a method for a graphene-based apparatus in accordance with an embodiment of the present invention; FIGS. 2A-2E are exemplary diagrams of depicting a graphene-based apparatus corresponded to the steps in FIG. 1. In this embodiment, The method is to form a graphene layer on a desired substrate, which comprises acts of S10 forming a graphene layer 10 on a metal layer 12, S11 forming a protective layer 14 on the graphene layer 10 that makes the graphene layer 10 disposed between the metal layer 12 and the protective layer 14, S12 transferring the protective layer 14 with the graphene layer 10 and the metal layer 12 onto a substrate 16, S13 removing the metal layer 12 off from the graphene layer 10, and S14 forming a conducting layer 18 on the graphene layer 10.

In the process step of S10, shown in FIG. 2A, the metal layer 12 is provided and a chemical vapor deposition (CVD) is performed to make the graphene layer 10 synthesized on the metal layer 12. The metal layer 12 may be made of Copper (Cu) or Nickel (Ni), and has a thickness in a range of 1-30 micrometers (μm). In some embodiment, the graphene layer 10 may be a single-layered or a multi-layered structure, and has a thickness in a range of 0.220 nanometers (nm).

In the process step of S11, shown in FIG. 2B, the protective layer 14 is coated on an open surface of the graphene layer 10 over the metal layer 12, and is configured to absorb stress which prevents the graphene layer 10 from damage. The protective layer 14 may be made from a material of an epoxy-based polymer such as the epoxy-based negative photoresist. The epoxy-based negative photoresist, for example, may be SU-8. The thickness of the protective layer 14 may be in a range of 0.1˜50 μm. The coating of the protective layer 14 may be implemented using a spin-coat or slit-casting technique.

In the process step of S12, shown in FIG. 2C, the substrate 16 is provided, and the protective layer 14 (i.e. the protective layer 14, shown in FIG. 2B, originally is on the top of the metal layer 12) is turned up side down and is pressed to attach onto the substrate 16. In an embodiment, the thickness of the substrate 16 may be in a range of 10˜500 μm. The protective layer 14 may then be cured by exposing to an UV light or heat.

It is noted, as shown in FIGS. 2B and 2C, that the graphene layer 10 synthesized on the metal layer 12 requires a transferring step before it can be utilized, and the graphene layer 10 (shown in FIG. 2B) is now fully protected by the metal layer 12 and the protective layer 14. In other words, the protective layer 14 between the graphene layer 10 and the substrate 16 acts as a buffer layer which can absorb the stress during the transferring step and prevent the damage of graphene. Because the use of the protective layer 14 in the structure, the roller can be used to apply the stress which enables roll-to-roll type process and significantly improves the manufacturing throughput.

In the process step of S13, shown in FIG. 2D, a wet-etching technique may be used to remove the metal layer 12 from the graphene layer 10. Furthermore, an additional chemical process can be implemented for chemical doping of the graphene layer 10 that reduces its resistance. However, it is not necessary to add dopant to the graphene layer. Such additional process is an optional step based on the application of the graphene-based apparatus.

After the metal layer 12 has been removed, in the process step of S14, shown in FIG. 2E, the conducting layer 18 is formed on the surface of the graphene layer 10 where the metal layer 12 is removed, and thus the layered structure of the graphene-based apparatus is formed. The added conducting layer 18 is able to enhance the uniformity of the resistivity by bridging any discontinues graphene areas. In an embodiment, the conducting layer 18 is an ultra-thin layer of a solution processable conductive material such as PEDOT:PSS, silver nanowires, or carbon nanotubes, and may be applied using the spin-coat or slit-casting technique for coating the conducting layer 18 on the graphene layer 10.

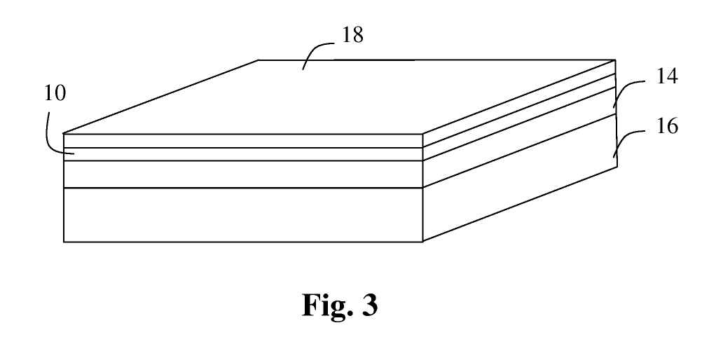

Accordingly, as shown in FIGS. 2E and 3, FIG. 3 is an exemplary diagram of depicting a graphene-based apparatus in accordance with an embodiment of the present invention. In this embodiment, the graphene-based apparatus is provided with characteristics of a high uniformity, conductivity, flexibility, and transparency that can be used for various applications, which comprises the conducting layer 18, a graphene layer 10, the protective layer 14 and a substrate 16 stacked vertically. In one embodiment, the transparent graphene-based apparatus can be utilized for making a solar cell, a light emitting diode, a battery, a super capacitor, an anti-static device, a electro-chromic device, a electro-wetting device or a touch panel.

Therefore, though the mentioned apparatuses and methods, the embodiments of the present invention are able to produce the graphene apparatus more efficiently.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method for a graphene-based apparatus, comprising:
forming a graphene layer on a metal layer;
forming a protective layer on the graphene layer that makes the graphene layer disposed between the metal layer and the protective layer;
transferring the protective layer with the graphene layer and the metal layer onto a substrate;
removing the metal layer from the graphene layer; and
forming a conducting layer on the graphene layer.

2. The method as claimed in claim 1, further comprising:
adding a dopant to the graphene layer after the metal layer has been removed from the graphene layer.

3. The method as claimed in claim 1, wherein the act of forming a graphene layer on a metal layer is performed using a chemical vapor deposition (CVD) technique.

4. The method as claimed in claim 1, wherein the act of forming a protective layer on the graphene layer is performed using a spin-coat or slit-casting technique.

5. The method as claimed in claim 1, wherein the act of transferring the protective layer turning the protective layer up side down that attaches onto the substrate, and the protective layer is a stress absorbing layer.

6. The method as claimed in claim 1, wherein a thickness of the metal layer is in a range of 1 to 30 micrometers, a thickness of the graphene layer is in a range of 0.2 to 20 nanometers, a thickness of the protective layer is in a range of 0.1 to 50 micrometers, and a thickness of the substrate is in a range of 10 to 500 micrometers.

7. The method as claimed in claim 1, wherein the protective layer is made from a material of an epoxy-based polymer, and the metal layer is made of a Copper or a Nickel.

8. A device for a graphene-based apparatus, comprising:
a substrate;
a protective layer being formed on the substrate;
a graphene layer being formed on the protective layer, wherein the protective layer is configured for preventing the damage of the graphene layer; and
a conductive layer being formed on the graphene layer, and being configured for enhancing the uniformity.

9. The device as claimed in claim 8, wherein the graphene-based apparatus is configured for making a solar cell, a light emitting diode, a battery, a super capacitor, an anti-static device, a electro-chromic device, a electro-wetting device, or a touch panel.
